(19) United States
(12) Patent Application Publication
(10) Pub. No.: US 2010/0036083 A1
(43) Pub. Date: Feb. 11, 2010

(54) Process For The Preparation Of Polyamides In The Presence of a Phosphonate

(75) Inventors: Jochen Fink, Nussloch (DE); Rudolf Pfaendner, Rimbach (DE); Dirk Simon, Lorrach-Brombach (DE); Constantine D. Papaspyrides, Athens (GR); Stamatina N. Vougiouka, Athens (GR)

Correspondence Address: JoAnn Villamizar;Ciba Corporation/Patent Department, 540 White Plains Road, P.O. Box 2005, Tarrytown, NY, 10591, US

(73) Assignee: CIBA SPECIALTY CHEMICALS CORPORATION, TARRYTOWN, NY (US)

(21) Appl. No.: 11/988,198

(22) PCT Filed: Jun. 28, 2006
(86) PCT No.: PCT/EP2006/063615

§ 371 Date: Oct. 28, 2009

(30) Foreign Application Priority Data
Jul. 7, 2005 (EP) 05106168.7

(51) Int. Cl. C08G 73/10; C09K 3/00

(52) U.S. Cl. 528/321; 528/336; 252/182.14

(57) ABSTRACT

The invention relates to the preparation of polyamides in the presence of a phosphonate, which is already added at the beginning of the polycondensation or polyaddition process. The resulting prepolymer exhibits a high molecular weight and is almost colorless. A further aspect of the invention is the use of a phosphonate for increasing the molecular weight and modification of polyamides during polycondensation.

The present invention relates to the preparation of polyamides in the presence of a phosphonate, which is already added at the beginning of the polycondensation or polyaddition process. The resulting prepolymer exhibits a high molecular weight and is almost colorless. A further aspect of the invention is the use of a phosphonate for increasing the molecular weight and modification of polyamides during polycondensation or polyaddition.

Polycondensates, in particular polyamides are widely used as plastic articles in textiles, construction, electrical & electronic appliances, household articles, packaging etc.

Polyamides for example are generally formed by two methods. The first method is a condensation reaction between diamines and diacids via a “nylon salt” as intermediate. The first number of the “nylon type” refers to the number of carbon atoms in the diamine, the second refers to the respective diacid (e.g. nylon 6.12 or nylon 6.6). The second process involves ring opening of a monomer containing both amine and acid groups known as lactam. The polyamide identity is based on the number of atoms in the lactam monomer (e.g. nylon 6 or nylon 12 etc). The mechanical and physical properties depend essentially on the molecular weight of the polymer. Polycondensates—in general—are prepared by further condensation of a prepolymer in the melt. High molecular weights can thus be obtained. For some applications, for example, drink packs and technical fibers, even higher molecular weights are necessary. These can be obtained by solid state polycondensation (s. Fakirov, Kunststoffe, 74 (1984), 218 and R. E. Grützner, A. Koine, Kunststoffe, 82 (1992), 284). The polymer is subjected to thermal treatment above the glass transition temperature and below the melt temperature of the polymer under inert gas or under vacuum. However, this method is very time and energy consuming. Increasing the intrinsic viscosity requires a residence time of up to 12 hours under vacuum or under inert gas at temperatures from 180° C. to 240° C.

The majority of polyamides tend to be semi-crystalline and are generally very tough materials with good thermal and chemical resistance. The different types give a wide range of properties with specific gravity, melting point and moisture uptake.

It is the objective of the instant invention to increase the molecular weight build up of polyamides already in the prepolymer stage. Under prepolymer stage there is understood the polymer, which is obtained in the first polycondensation or polyaddition step starting from the monomers.

Surprisingly it has been found that the synthesis of polyamides in the presence of phosphonates improves the color of the prepolymer and accelerates the molecular weight build up. The improvement is significantly higher when the phosphonate is added already at the beginning of the polycondensation or polyaddition process, compared with the addition during melt polycondensation or solid state polycondensation (SSP) as, for example, disclosed in WO 96/11978.

One aspect of the invention is a process for the preparation of a polyamide prepolymer comprising, starting from a diacid and a diamine monomer or from a lactam monomer and carrying out a polycondensation or polyaddition reaction in the presence of a phosphonate. (Anspruch 1)

Polyamides, i.e. both virgin polyamides and polyamide recyclates, are understood to be, for example, aliphatic and aromatic polyamides or copolyamides which are derived from diamines and dicarboxylic acids and/or of aminocarboxylic acid or the corresponding lactams. Suitable polyamides are for example: PA 6, PA 11, PA 12, PA 46, PA 66, PA 69, PA 610, PA 612, PA 10.12, PA 12.12 and also amorphous polyamides and thermoplastic polyamide elastomers such as polyether amides of the Vestamid, Grilamid ELY60, Pebax, Nyim and Grilon ELX type. Polyamides of the cited types are commonly known and are commercially available.

EP-A-0 613 919, for example, discloses the preparation and use of typical polyether ester amides.

The polyamides used are preferably crystalline or partially crystalline polyamides and, in particular, PA6 and PA6.6 or their blends.

Polyamides and copolyamides are derived from diamines and dicarboxylic acids and/or from aminocarboxylic acids or the corresponding lactams, such as polyamide 4, polyamide 6, polyamide 6,6, 6,10, 6,9, 6,12, 4,6, 12,12, polyamide 11, polyamide 12, aromatic poly-amides derived from m-xylylene, diamine and adipic acid; polyamides prepared from hexamethylenediamine and iso- and/or tere-phthalic acid and optionally an elastomer as modifier, for example poly-2,4,4-trimethylhexamethyleneterephthalamide or poly-m-phenylene-isophthalamide.

For example, the monomers are selected from the group consisting of tetramethylenediamine, hexamethylenediamine, diaminodecane, diaminododecane, adipic acid, azelaic acid, sebacic acid, dodecanedioic acid, ε-caprolactam, undecanlactam, laurolactam and mixtures thereof. (Anspruch 2)

Preferably the monomers comprise hexamethylenediamine and adipic acid. (Anspruch 4)

For instance the polyamide prepolymer is a polamide PA 4.6, PA 6.6; PA 6.9; PA 6.10, PA 6.12, PA 10.12, PA 12.12, PA 6, PA 11, PA 12 or PA 6/66 blend. (Anspruch 3)

For example the phosphonates are of formula I

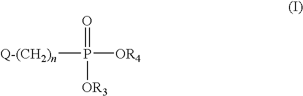

are preferred, wherein
R₃ is H, C₁-C₂₀alkyl, unsubstituted or C₁-C₄alkyl-substituted phenyl or naphthyl,
R₄ is hydrogen, C₁-C₂₀alkyl, unsubstituted or C₁-C₄alkyl-substituted phenyl or naphthyl; or M^{r+}/r,
M^{r+} is an r-valent metal cation or the ammonium ion,
n is 0, 1, 2, 3, 4, 5 or 6, and
r is 1, 2, 3 or 4;
Q is hydrogen, —X—C(O)—OR₇, or a radical

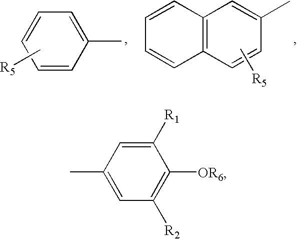

R₁ is isopropyl, tert-butyl, cyclohexyl, or cyclohexyl which is substituted by 1-3 C₁-C₄alkyl groups,
R₂ is hydrogen, C₁-C₄alkyl, cyclohexyl, or cyclohexyl which is substituted by 1-3 C₁-C₄alkyl groups,
R₅ is H, C₁-C₁₈alkyl, OH, halogen or C₃-C₇cycloalkyl;
R₆ is H, methyl, trimethylsilyl, benzyl, phenyl, sulfonyl or C₁-C₁₈alkyl;
R₇ is H, C₁-C₁₀alkyl or C₃-C₇cycloalkyl; and
X is phenylene, C₁-C₄alkyl group-substituted phenylene or cyclohexylene.

### (Anspruch 5)

Other suitable phosphonates are listed below.

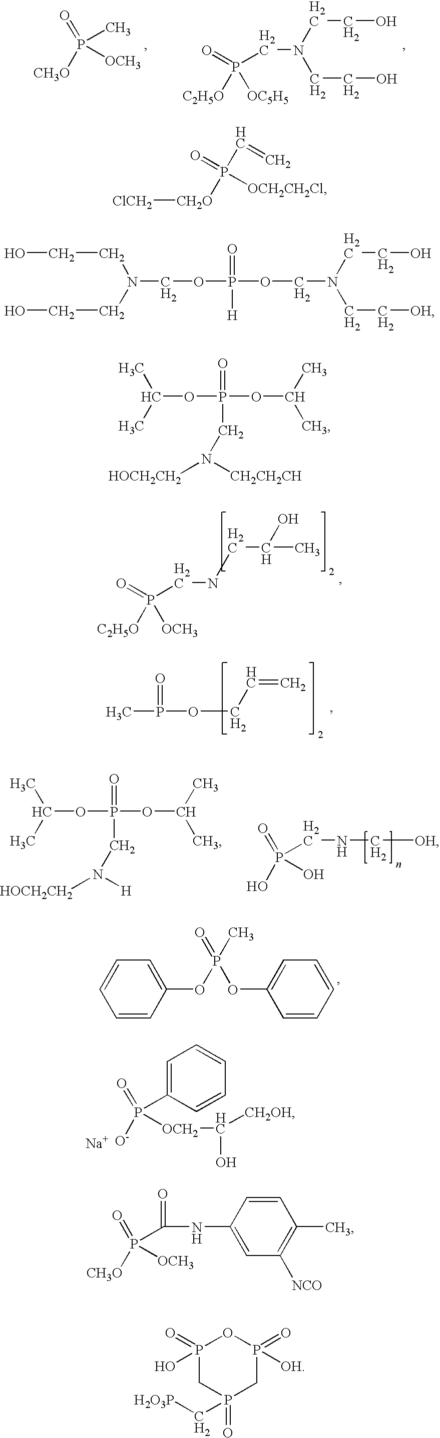

Sterically hindered hydroxyphenylalkylphosphonic acid esters or half-esters, such as those known from U.S. Pat. No. 4,778,840, are preferred.

Particularly preferred compounds are those of formula Ia

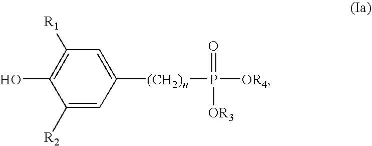

wherein
R₁ is H, isopropyl, tert-butyl, cyclohexyl, or cyclohexyl which is substituted by 1-3 C₁-C₄alkyl groups,
R₂ is hydrogen, C₁-C₄alkyl, cyclohexyl, or cyclohexyl which is substituted by 1-3 C₁-C₄alkyl groups,
R₃ is C₁-C₂₀alkyl, unsubstituted or C₁-C₄alkyl-substituted phenyl or naphthyl,
R₄ is hydrogen, C₁-C₂₀alkyl, unsubstituted or C₁-C₄alkyl-substituted phenyl or naphthyl; or M^{r+}/r,
M^{r+} is an r-valent metal cation,
n is 1, 2, 3, 4, 5 or 6, and

### r is 1, 2, 3 or 4. (Anspruch 6)

Halogen is fluoro, chloro, bromo or iodo.

Alkyl substituents containing up to 18 carbon atoms are suitably radicals such as methyl, ethyl, propyl, butyl, pentyl, hexyl and octyl, stearyl and also corresponding branched isomers; C₂-C₄alkyl and isooctyl are preferred.

C₁-C₄Alkyl-substituted phenyl or naphthyl which preferably contain 1 to 3, more preferably 1 or 2, alkyl groups is e.g. o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl, 2,6-diethylphenyl, 1-methylnaphthyl, 2-methyl-naphthyl, 4-methylnaphthyl, 1,6-dimethylnaphthyl or 4-tert-butylnaphthyl.

C₁-C₄Alkyl-substituted cyclohexyl which preferably contains 1 to 3, more preferably 1 or 2, branched or unbranched alkyl group radicals, is e.g. cyclopentyl, methylcyclopentyl, dimethylcyclopentyl, cyclohexyl, methylcyclohexyl, dimethylcyclohexyl, trimethylcyclohexyl or tert-butylcyclohexyl.

A mono-, di-, tri- or tetra-valent metal cation is preferably an alkali metal, alkaline earth metal, heavy metal or aluminium cation, for example Na⁺, K⁺, Mg⁺⁺, Ca⁺⁺, Ba⁺⁺, Zn⁺⁺, Al⁺⁺⁺, or Ti⁺⁺⁺⁺. Ca⁺⁺ is particularly preferred.

Preferred compounds of formula Ia are those containing at least one tert-butyl group as R₁ or R₂. Very particularly preferred compounds are those, wherein R₁ and R₂ are at the same time tert-butyl.

n is preferably 1 or 2 and, very particularly preferably, 1.

Very particularly preferred sterically hindered arylalkylphosphonic acid esters or half-esters are the compounds of formula II, III, IV, V and VI

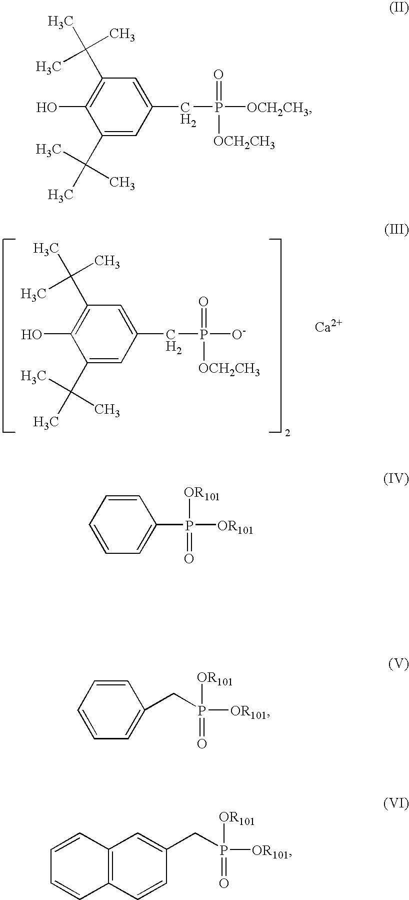

wherein the R₁₀₁ are each independently of one another hydrogen, ethyl, phenyl or M^{r+}/r. Meanings of M^{r+}/r have been cited above. (Anspruch 7)

Some of the compounds II, III, IV, V and VI are commercially available or can be prepared by standard processes.

For example 10 to 20 000 ppm, preferably 1000 to 10 000 ppm and in particular 200 to 2000 ppm of the phosphonate per monomer or monomers are used (ppm means parts per million by weight). (Anspruch 8)

Preferably the phosphonate is added directly to the monomers and then the reaction is started. In some cases a later addition may also be possible.

Preferably the polycondensation or polyaddition temperature is between 150° C. and 280° C., in particular between 200° C. and 250° C. (Anspruch 9)

Typically the reaction is carried out under pressure. Preferably the pressure during the polycondensation or polyaddition reaction is between 3 and 20 bar, in particular between 5 and 15 bar. (Anspruch 10)

The reaction is usually carried out under inert gas atmosphere.

The reaction can be carried out in any suitable vessel to which pressure can be applied. Polycondensation processes are widely described and known to the skilled person.

The polyamide prepolymer may be further processed, such as for example by a further melt polycondensation or by a solid state polycondensation (SSP) step.

In a specific embodiment of the invention a subsequent solid state polycondensation is applied to the polyamide prepolymer. (Anspruch 11)

The solid state polycondensation is typically carried out between 180° C. and 240° C.

As already mentioned, the polyamide prepolymer prepared according to the process described above exhibits no or only an off-white color and a higher molecular weight compared with prior art polyamides, as measured, for example, by the melt flow rate.

It is also possible to add further reactive additives in these processing steps to achieve the desired properties. Examples are given below.

### 1. Epoxide Compounds:

I) Polyglycidyl and poly(β-methylglycidyl) esters obtainable by reacting a compound having at least two carboxyl groups in the molecule and epichlorohydrin and/or glycerol dichlorohydrin and/or β-methylepichlorohydrin. The reaction is judiciously carried out in the presence of bases.

As compounds having at least two carboxyl groups in the molecule it is possible to use aliphatic polycarboxylic acids. Examples of these polycarboxylic acids are glutaric, adipic, pimelic, suberic, azelaic, sebacic and dimerized or trimerized linoleic acid.

It is however also possible to employ cycloaliphatic polycarboxylic acids, examples being tetrahydrophthalic, 4-methyltetrahydrophthalic, hexahydrophthalic and 4-methylhexahydrophthalic acid.

Furthermore, aromatic polycarboxylic acids can be used, such as phthalic, isophthalic, trimellitic and pyromellitic acid.

It is also possible to make use of carboxyl-terminated adducts of, for example, trimellitic acid with polyols, such as glycerol or 2,2-bis(4-hydroxycyclohexyl)propane.

II) Polyglycidyl or poly(β-methylglycidyl)ethers obtainable by reacting a compound having at least two free alcoholic hydroxyl groups and/or phenolic hydroxyl groups and a suitably substituted epichlorohydrin under alkaline conditions or in the presence of an acidic catalyst with subsequent alkali treatment.

Ethers of this type are derived, for example, from acyclic alcohols, such as ethylene glycol, diethylene glycol and higher poly(oxyethylene) glycols, propane-1,2-diol, or poly-(oxypropylene)glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, bistrimethylolpropane, pentaerythritol, sorbitol, and from polyepichlorohydrins.

However they are also derived, for example, from cycloaliphatic alcohols such as 1,3- or 1,4-dihydroxycyclohexane, bis(4-hydroxycyclohexyl)methane, 2,2-bis(4-hydroxycyclohexyl)-propane or 1,1-bis(hydroxymethyl)-cyclohex-3-ene, or they possess aromatic nuclei, such as N,N-bis(2-hydroxyethyl)aniline or p, p′-bis(2-hydroxyethylamino)diphenylmethane.

The epoxide compounds may also be derived from mononuclear phenols, such as from resorcinol or hydroquinone; or they are based on polynuclear phenols such as on bis(4-hydroxyphenyl)methane, 2,2-bis(4-hydroxyphenyl)propane, 2,2-bis(3,5-dibromo-4-hydroxyphenyl)propane, 4,4′-dihydroxydiphenyl sulfone, or on condensation products of phenols with formaldehyde that are obtained under acidic conditions, such as phenol novolaks.

III) Poly(N-glycidyl) compounds obtainable by dehydrochlorination of the reaction products of epichlorohydrin with amines containing at least two amino hydrogen atoms. Examples of these amines are aniline, toluidine, n-butylamine, bis(4-aminophenyl)methane, m-xylylenediamine and bis(4-methylaminophenyl)methane, and also N,N,O-triglycidyl-m-amino-phenol and N,N,O-triglycidyl-p-aminophenol.

The poly(N-glycidyl) compounds also, however, include N,N′-diglycidyl derivatives of cycloalkylene ureas, such as ethylene urea or 1,3-propylene urea, and N,N′-diglycidyl derivatives of hydantoins, such as of 5,5-dimethylhydantoin.

IV) Poly(S-glycidyl) compounds, such as di-S-glycidyl derivatives derived from dithiols such as ethane-1,2-dithiol or bis(4-mercaptomethylphenyl)ether.

Examples of suitable epoxides are:

a) liquid bisphenol A diglycidyl ethers such as Araldit® GY 240, Araldit® GY 250, Araldit® GY 260, Araldit® GY 266, Araldit® GY 2600, Araldit® MY 790;
b) solid bisphenol A diglycidyl ethers such as Araldit® GT 6071, Araldit® GT 7071, Araldit® GT 7072, Araldit® GT 6063, Araldit® GT 7203, Araldit® GT 6064, Araldit® GT 7304, Araldit® GT 7004, Araldit® GT 6084, Araldit® GT 1999, Araldit® GT 7077, Araldit® GT 6097, Araldit® GT 7097, Araldit® GT 7008, Araldit® GT 6099, Araldit® GT 6608, Araldit® GT 6609, Araldit® GT 6610;
c) liquid bisphenol F diglycidyl ethers such as Araldit® GY 281, Araldit® GY282, Araldit® PY 302, Araldit® PY 306;
d) solid polyglycidyl ethers of tetraphenylethane such as CG Epoxy Resin® 0163;
e) solid and liquid polyglycidyl ethers of phenol-formaldehyde novolak such as EPN 1138, EPN 1139, GY 1180, PY 307;
f) solid and liquid polyglycidyl ethers of o-cresol-formaldehyde novolak such as ECN 1235, ECN 1273, ECN 1280, ECN 1299;
g) liquid glycidyl ethers of alcohols such as Shell® Glycidyl ether 162, Araldit® DY 0390, Araldit® DY 0391;
h) liquid glycidyl ethers of carboxylic acids such as Shell® Cardura E terephthalic ester, trimellitic ester, Araldit® PY 284;
i) solid heterocyclic epoxy resins (triglycidyl isocyanurate) such as Araldit® PT 810;
j) liquid cycloaliphatic epoxy resins such as Araldit® CY 179;
k) liquid N,N,O-triglycidyl ethers of p-aminophenol such as Araldit® MY 0510;
l) tetraglycidyl-4,4′-methylenebenzamine or N,N,N′,N′-tetraglycidyidiaminophenylmethane such as Araldit® MY 720, Araldit® MY 721.

2. Bisoxazolines, bisoxazines, bisoxazolones or acyllactams. Compounds from these classes are described, for example, in EP-A-0 583 807 and in EP-A-0 785 967.

Preferred difunctional compounds from the class of the bisoxazolines are described by T. Loontjens et al., Makromol. Chem., Macromol. Symp. 75, 211-216 (1993) and are for example compounds of the formula

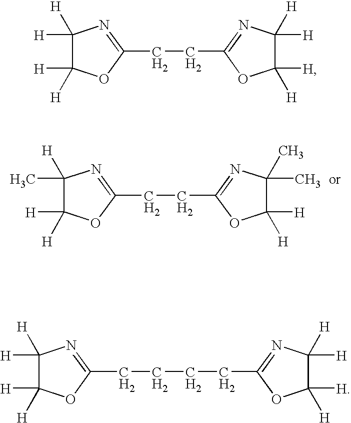

Polyfunctional, especially difunctional, compounds from the class of the oxazines or oxazolones are known and are described for example by H. Inata et al., J. Applied Polymer Science Vol. 32, 4581-4594 (1986); 2,2′-bis(4H-3,1-benzoxazin-4-one) is particularly preferred.

Polyfunctional, especially difunctional, compounds from the class of the acyllactams are for example compounds of the formula

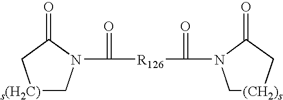

in which s is from 1 to 16, especially from 5 to 10, and
R₁₂₆ is an aromatic radical.

Preference is given to acyllactams of the formula in which the lactam rings are caprolactam or laurolactam.

3. Diisocyanates, such as tetramethylene diisocyanate, hexamethylene diisocyanate, dodecamethylene diisocyanate, eicosane 1,20-diisocyanate, 4-butylhexamethylene diisocyanate, 2,2,4- or 2,4,4-trimethylhexamethylene diisocyanate, OCN(CH₂)₂O(CH₂)₂NCO, toluene-2,4-diisocyanate, p-phenylene diisocyanate, xylylene diisocyanates, 3-isocyanatomethyl-3,5,5-trimethylcyclohexyl isocyanate, naphthalene diisocyanates, sulfonyl diisocyanates, 3,3′-, 4,4′- and 3,4′-diisocyanates of diphenylmethane, 2,2-diphenylpropane and diphenyl ether, 3,3′-dimethyl-4,4′-diisocyanatobiphenyl, 3,3′-dimethoxy-4,4′-diisocyanatobiphenyl and 4,4′-diisocyanatodiphenylmethane.

4. Dicyanates such as bisphenol A dicyanate.

5. Tetracarboxylic dianhydrides, such as pyromellitic dianhydride or 3,3′,4,4′-benzophenone-tetracarboxylic dianhydride.

6. Bismaleimides such as diphenylmethanebismaleimide or 1,3-phenylenebismaleimide.

7. Carbodiimides such as poly(2,4,6-triisopropyl-1,3-phenylenecarbodiimide).

In addition to the above mentioned phosphonates and reactive additives it is also possible to employ further additives. Examples are given below.

### 1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethyl-phenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydroxyphenyl) adipate.

1.4. Tocopherols, for example α-tocopherol, β-tocopherol, γ-tocopherol, δ-tocopherol and mixtures thereof (Vitamin E).

1.5. Hydroxylated thiodiphenyl ethers, for example 2, 2′-thiobis(6-tert-butyl-4-methylphenol), 2,2′-thiobis(4-octyl phenol), 4,4′-thiobis(6-tert-butyl-3-methyl phenol), 4,4′-thiobis(6-tert-butyl-2-methylphenol), 4,4′-thiobis-(3,6-di-sec-amylphenol), 4,4′-bis(2,6-dimethyl-4-hydroxyphenyl)disulfide.

1.6. Alkylidenebisphenols, for example 2, 2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methyllenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3, 5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis-(3,5-di-tert-butyl-2-hydroxybenzyl)-malonate, di-octadecyl-2-(3-tert-butyl-4-hydroxy-5-methylbenzyl)-malonate, didodecylmercaptoethyl-2,2-bis-(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris-(3,5-di-tert-butyl-4-hydroxybenzyl)-2,4,6-trimethylbenzene, 1,4-bis(3,5-di-tert-butyl-4-hydroxybenzyl)-2,3,5,6-tetramethyl benzene, 2,4,6-tris(3,5-di-tert-butyl-4-hydroxybenzyl)phenol.

1.10. Triazine Compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanil ino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethyllene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenyl propionyl)hexamethylenediamine, N N′-bis(3,5-di-tert-butyl-4-hydroxy-phenylpropionyl)trimethylenediamine, N,N′-bis(3,5-di-tert-butyl-4-hydroxyphenylpropionyl)-hydrazide, N,N′-bis[2-(3-[3,5-di-tert-butyl-4-hydroxyphenyl]propionyloxy)ethyl]oxamide (Naugard® XL-1 supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxy-diphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenyl, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyidiphenylamines, a mixture of mono- and dialkylated nonyidiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- und dialkylated tert-butyl/tert-octylphenothiazines, a mixture of mono- und dialkylated tert-octyl-phenothiazines, N-allylphenothiazin, N,N,N′,N′-tetraphenyl-1,4-diaminobut-2-ene, N,N-bis-(2,2,6,6-tetramethyl-piperid-4-yl-hexamethylenediamine, bis(2,2,6,6-tetramethylpiperid-4-yl)-sebacate, 2,2,6,6-tetramethylpiperidin-4-one, 2,2,6,6-tetramethylpiperidin-4-ol.

### 2. UV Absorbers and Light Stabilisers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂₂ where R=3′-tert-butyl-4′-hydroxy-5′-2H-benzotriazol-2-ylphenyl, 2-[2′-hydroxy-3′-(α,α-dimethyl benzyl)-5′-(1,1,3,3-tetramethylbutyl)-phenyl]benzotriazole; 2-[2′-hydroxy-3′-(1,1,3,3-tetramethylbutyl)-5′-(α,α-dimethyl benzyl)-phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, as for example 4-tertbutyl-phenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butyl phenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxy-cinnamate, butyl α-cyano-β-methyl-p-methoxy-cinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thio-bis-[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenyl undecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylimino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethyl piperidyl)-2-n-butyl-2-(2-hydroxy-3,5-di-tert-butylbenzyl)malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cyclounaecyl-1-oxa-3,8-diaza-4-oxospiro[4,5]decane und epichlorohydrin, 1,1-bis(1,2,2,6,6-pentamethyl-4-piperidyloxycarbonyl)-2-(4-methoxyphenyl)ethene, N N′-bisformyl-N,N′-bis(2,2,6,6-tetramethyl-4-piperidyl)hexamethylenediamine, diester of 4-methoxymethylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

2.7. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2, 4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis-(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxy-propyloxy)phenyl]-4,6-bis(2,4-dimethyl)-1,3,5-triazine, 2-[4-(dodecyloxy/tridecyloxy-2-hydroxypropoxy)-2-hydroxy-phenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal deactivators, for example N,N′-diphenyloxamide, N-salicylic-N′-salicyloyl hydrazine, N,N′-bis(salicyloyl) hydrazine, N,N′-bis(3,5-di-tert-butyl-4-hydroxyphenylpropionyl) hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphate, tetrakis(2,4-di-tert-butylphenyl) 4,4′-biphenylene diphosphonate, 6-isooctyloxy-2,4,8,10-tetra-tert-butyl-12H-dibenz[d,g]-1,3,2-dioxaphosphocin, 6-fluoro-2,4,8,10-tetra-tert-butyl-12-methyl-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-di-yl)phosphite.

Especially preferred are the following phosphites:

Tris(2,4-di-tert-butylphenyl) phosphite (Irgafos® 168, Ciba-Geigy), tris(nonylphenyl) phosphite,

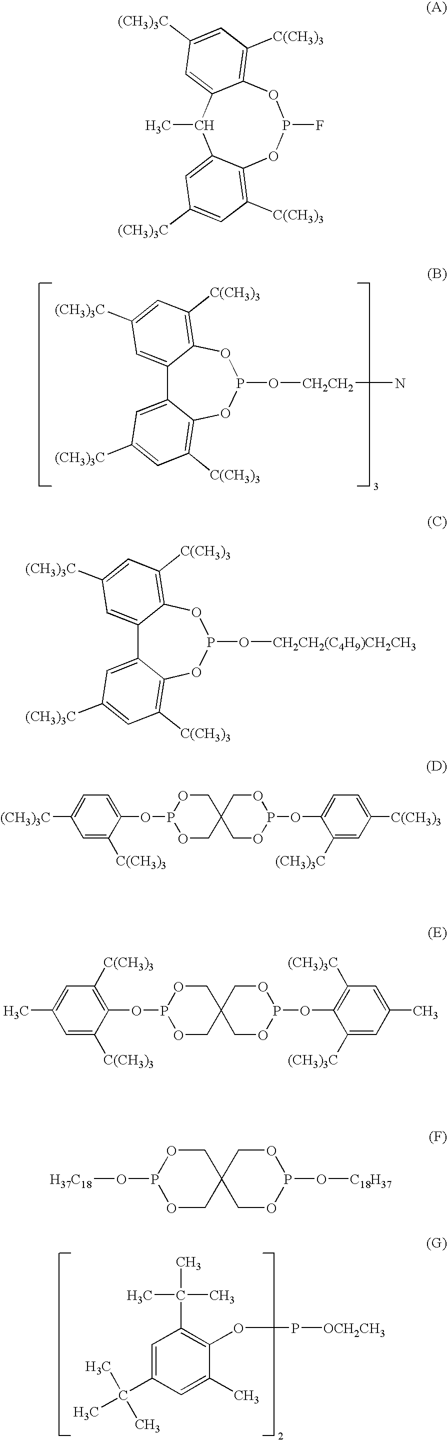

5. Hydroxylamines, for example, N,N-dibenzylhydroxylamine, N,N-diethylhydroxylamine, N,N-dioctylhydroxylamine, N,N-dilaurylhydroxylamine, N,N-ditetradecyl hydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenyl-nitrone, N-ethyl-alpha-methyl-nitrone, N-octyl-alpha-heptyl-nitrone, N-lauryl-alpha-undecyl-nitrone, N-tetradecyl-alpha-tridecyl-nitrone, N-hexadecyl-alpha-pentadecyl-nitrone, N-octadecyl-alpha-heptadecyl-nitrone, N-hexadecyl-alpha-heptadecyl-nitrone, N-octadecyl-alpha-pentadecyl-nitrone, N-heptadecyl-alpha-heptadecyl-nitrone, N-octadecyl-alpha-hexadecyl-nitrone, nitrone derived from N,N-dialkylhydroxylamine derived from hydrogenated tallow amine.

7. Thiosynergists, for example, dilauryl thiodipropionate or distearyl thiodipropionate.

8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Polyamide stabilisers, for example, copper salts in combination with iodides and/or phosphorus compounds and salts of divalent manganese.

10. Basic co-stabilisers, for example, melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids for example calcium stearate, zinc stearate, magnesium behenate, magnesium stearate, sodium ricinoleate and potassium palmitate, antimony pyrocatecholate or zinc pyrocatecholate.

11. Nucleating agents, for example, inorganic substances such as talcum, metal oxides such as titanium dioxide or magnesium oxide, phosphates, carbonates or sulfates of, preferably, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers).

12. Fillers and reinforcing agents, for example, calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

13. Other additives, for example, plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839 or EP-A-0591102 or 3-[4-(2-acetoxyethoxy)-phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butylbenzofuran-2-one, 3-(3,4-dimethylphenyl)-5,7-di-tert-butyl-benzofuran-2-one, 3-(2,3-dimethylphenyl)-5,7-di-tert-butyl-benzofuran-2-one.

Preference is given in this context to light stabilizers from classes 2.1, 2.6 and 2.7, such as light stabilizers of the type Chimassorb 944, Chimassorb 119, Tinuvin 234, Tinuvin 312, Tinuvin 622 or Tinuvin 770. Preference is also given to aromatic phosphites or phosphonites. Likewise preferred is a process in which a phosphite and/or a sterically hindered phenol are/is employed in addition. Preference is also given to polyamide stabilisers, for example, copper salts in combination with iodides and/or phosphorus compounds and salts of divalent manganese.

The additives can be added and mixed with the polymer in any vessel which can be heated and fitted with a stirring device. These may, for example, be closed apparatus, such as kneading devices, mixers or stirred vessels. The mixing process is preferably conducted in an extruder or kneading device. It is unimportant whether the process is operated under an inert atmosphere or in the presence of atmospheric oxygen.

The phosphonate can be dissolved or dispersed in one or more monomers or in the nylon salt and thereby added to the polycondensation or polyaddition reaction. It is also possible to add the phosphonate as powder or liquid directly into the reaction vessel. Moreover, the phosphonate can be added at any stage of the polycondensation or polyaddition reaction. Alternatively, a solid or molten masterbatch of the phosphonate in a polymide carrier can be used to add the additive at any stage of the reaction.

Preferably the phosphonate is present from the beginning of the reaction.

Also an aspect of the invention is a composition comprising

a) a diacid and a diamine monomer or a lactam monomer and
b) a phosphonate. (Anspruch 12)

Another aspect of the invention is the use of a phosphonate for the preparation of a polyamide prepolymer comprising starting from a diacid and a diamine monomer or from a lactam monomer and carrying out a polycondensation or polyaddition reaction in the presence of the phosphonate. (Anspruch 13)

Yet a further aspect is a polyamide obtainable according to the process described above. (Anspruch 14)

Preferences and definitions have already been given for the process. They apply also to the other aspects of the invention.

The following examples illustrate the invention.

### General Remarks:

### Measurement of Relative Viscosity (RV):

The relative viscosity (RV) of PA 6.6 is the ratio of the viscosity of a solution of 8.4 weight-% polymer in a solution of 90% formic acid to the viscosity of the formic acid solution. 5.5 g polymer are dissolved in 50 ml formic acid (90%). Viscosity measurements are performed using a Cannon-Fenske viscometer at 25° C.

### Solid State Polycondensation (SSP):

Before SSP is carried out, every sample (extruded or synthesized PA 6,6) is dried under vacuum at 80° C. for 2 hours.

Synthesis of Polyamide 6.6:

### First Step: Preparation of PA 6.6 Salt:

The reaction is carried out in a 500 ml flask equipped with two dropping funnels in a water bath at 32° C. In the first dropping funnel 13.92 g (0.119 mol) hexamethylenediamine are dissolved in 25 ml methanol, the other contains a solution of 17.70 g (0.120 mol) adipic acid in 80 ml methanol. Both solutions are simultaneously (during 2 min.) dropped into the flask and the temperature is increased up to 45-50° C. After addition is completed the flask is cooled down to 8° C. Immediately the PA 6.6 salt (=adipic acid/hexamethylenediamine salt) precipitates and is filtered off. After two times washing with 22 ml cold methanol the salt is dried at 60° C. in vacuum until constant weight and stored in a desiccator over P₂O₅ until use. The salt is obtained as white solid.

Conversion: 96-99%

Melting point: 186-187° C.

pH-value: ˜7.62

### Second Step: Preparation of Polyamide 6.6 (PA 6.6) Prepolymer

A 1I-Büchi autoclave is evacuated and vented with N₂ before use. 150 g adipic acid/hexamethylenediamine salt of the first step and 1000 ppm Irgamod 195 or Irgamod 295 respectively are added and the reactor is evacuated and vented with N₂ again. The mixture is stirred for 30 minutes and then the temperature is raised up to 225° C. After 1.5 h at this temperature at a pressure of 8-11 bar the autoclave is vented and the mixture is stirred 15 minutes under nitrogen atmosphere. After cooling down to room temperature the resulting polyamide 6.6 is removed mechanically and is grinded.

The polyamide is obtained as white powder.

| No. | Synthesized Polymer | Color |
|---|---|---|
| 1 comparative experiment | PA pure | slight yellow |
| | | powder |
| 2 comparative experiment | PA + 1000 ppm | white powder |
| | Irgafos ® 168 | |
| 3 according to the invention | PA + 1000 ppm | white powder |
| | Irgamod ® 295 | |
| 4 according to the invention | PA + 1000 ppm | white powder |
| | Irgamod ® 195 | |

Irgamod ® 195 is a commercial phosphonate from Ciba Specialty Chemicals Inc.

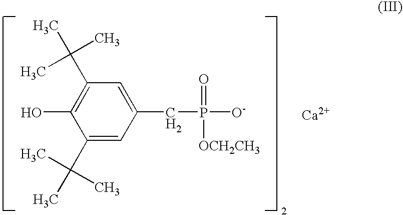

Irgamod® 295 is a commercial phosphonate from Ciba Specialty Chemicals Inc.

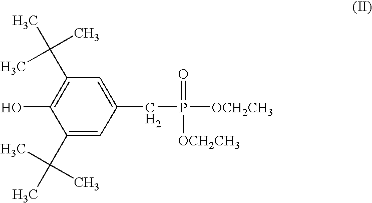

Irgafos® 168 is a commercial phosphite from Ciba Specialty Chemicals Inc. Tris(2,4-di-tert-butylphenyl) phosphite

### Third Step: Extrusion of PA 6.6

The grinded polymer (step2) is extruded in a twin screw extruder (Haake TW 100) at 260-280° C. and 50 rpm under vacuum. The resulting polyamide is strand granulated and the material is dried over night in vacuum before measurement of the MFR (in accordance with ISO 1133).

PA6.6 after extrusion (temp. profile 260-280° C., 50 rpm, vacuum)

| | Synthesized | | MFR | |
|---|---|---|---|---|
| No. | Polymer | Color | (275° C., 1.2 kg)) | RV |
| 0 comparative | Commercial grade | Off-white | 50 | 53 |
| | (Terez PA 66) | | | |
| 1 comparative | PA pure | Orange | 111 | 34 |
| 2 comparative | PA + 1000 ppm | Brown | 24 | 73 |
| | Irgafos 168 | | | |
| 3 inventive | PA + 1000 ppm | Off-white | 34 | 54 |
| | Irgamod 295 | | | |
| 4 inventive | PA + 1000 ppm | Off-white | 70 | 45 |
| | Irgamod 195 | | | |

MFR = Melt flow rate
RV = Relative viscosity

A comparison of the results indicates that the MFR measurement agree with the RV values. The synthesis without phosphonate (PA pure) results in a yellow polymer with low molecular weight (high MFR; low RV). Addition of Irgamod 195 or Irgamod 295 leads to a polyamide with high molecular weight—in case of Irgamod 295 a higher molecular weight as commercial grade (No. 1)—by unchanged good color. When using a phosphite, such as Irgafos 168 a high molecular weight polymer is obtained, however, with unacceptable color.

### CONCLUSION

These results demonstrate that the addition of a phosphonate, such as Irgamod 195 or Irgamod 295, from the beginning of the prepolymer preparation accelerates the molecular weight built up and affords a colorless polymer.

### Subsequent SSP:

With samples No. 3 and No. 4 (see third step) a solid state polycondensation at 200° C. under flowing nitrogen for 4 h is carried out. For comparative experiments a commercial PA 6.6 (Terez PA 66) with 1000 ppm of Irgamod 195 or with 1000 ppm Irgamod 295 respectively is subjected to SSP as well. These two mixtures are extruded (temp. profile 260-280° C.) and the resulting polymer samples are strand granulated. All samples are subjected to the same SSP procedures (samples No. 3 and No. 4 and comparative 3 and 4). The results are shown in the table below:

| | | SSP | | RV |
|---|---|---|---|---|
| | | 200° C. | RV | Increase |
| Comparative 3 | Terez PA 66 + 1000 ppm | 0 h | 65 | |
| | Irgamod 295 | 4 h | 151 | 132% |
| Inventive | PA prepared with 1000 ppm | 0 h | 68 | |
| exp. 3 | Irgamod 295 | 4 h | 262 | 288% |
| Comparative 4 | Terez PA 66 + 1000 ppm | 0 h | 59 | |
| | Irgamod 195 | 4 h | 151 | 158% |
| Inventive | PA prepared with 1000 ppm | 0 h | 56 | |
| exp. 4 | Irgamod 195 | 4 h | 185 | 230% |

Comparative 3 = Terez PA 66 + 1000 ppm Irgamod 295, extruded
Inventive exp. 3 = Synthesized PA 66 containing 1000 ppm Irgamod 295, extruded
Comparative 4 = Terez PA 66 + 1000 ppm Irgamod 195, extruded
Inventive exp. 4 = Synthesized PA 66 containing 1000 ppm Irgamod 195, extruded

These examples demonstrate that the additives are more efficient when added in the prepolymer preparation stage, than in a later processing step.

1. Process for the preparation of a polyamide prepolymer comprising, starting from a diacid and a diamine monomer or from a lactam monomer and carrying out a polycondensation or polyaddition reaction in the presence of a phosphonate.

2. A process according to claim 1 wherein the monomers are selected from the group consisting of tetramethylenediamine, hexamethylenediamine, diaminodecane, diaminododecane, adipic acid, azelaic acid, sebacic acid, dodecanedioic acid, ε-caprolactam, undecanlactam, laurolactam and mixtures thereof.

3. A process according to claim 1 wherein the polyamide prepolymer is a polamide PA 4.6, PA 6.6; PA 6.9; PA 6.10, PA 6.12, PA 10.12, PA 12.12, PA 6, PA 11, PA 12 or PA 6/66 blend.

4. A process according to claim 2 wherein the monomers comprise hexamethylenediamine and adipic acid.

5. A process according to claim 1 wherein the phosphonate is of formula I 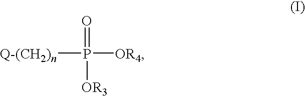
wherein
R₃ is H, C₁-C₂₀alkyl, unsubstituted or C₁-C₄alkyl-substituted phenyl or naphthyl,
R₄ is hydrogen, C₁-C₂₀alkyl, unsubstituted or C₁-C₄alkyl-substituted phenyl or naphthyl; or
M^{r+}/r,
M^{r+} is an r-valent metal cation or the ammonium ion,
n is 0, 1, 2, 3, 4, 5 or 6, and
r is 1, 2, 3 or 4;
Q is hydrogen, —X—C(O)—OR₇, or a radical 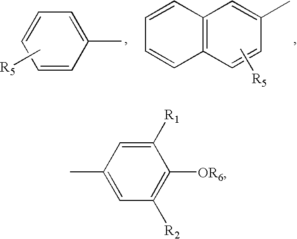
R₁ is isopropyl, tert-butyl, cyclohexyl, or cyclohexyl which is substituted by 1-3 C₁-C₄alkyl groups,
R₂ is hydrogen, C₁-C₄alkyl, cyclohexyl, or cyclohexyl which is substituted by 1-3 C₁-C₄alkyl groups,
R₅ is H, C₁-C₁₈alkyl, OH, halogen or C₃-C₇cycloalkyl;
R₆ is H, methyl, trimethylsilyl, benzyl, phenyl, sulfonyl or C₁-C₁₈alkyl;
R₇ is H, C₁-C₁₀alkyl or C₃-C₇cycloalkyl; and
X is phenylene, C₁-C₄alkyl group-substituted phenylene or cyclohexylene.

6. A process according to claim 5, wherein the phosphonate is of formula Ia 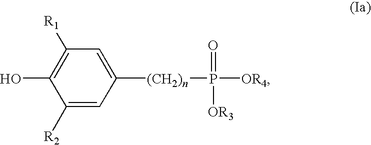
wherein
R₁ is H, isopropyl, tert-butyl, cyclohexyl, or cyclohexyl which is substituted by 1-3 C₁-C₄alkyl groups,
R₂ is hydrogen, C₁-C₄alkyl, cyclohexyl, or cyclohexyl which is substituted by 1-3 C₁-C₄alkyl groups,
R₃ is C₁-C₂₀alkyl, unsubstituted or C₁-C₄alkyl-substituted phenyl or naphthyl,
R₄ is hydrogen, C₁-C₂₀alkyl, unsubstituted or C₁-C₄alkyl-substituted phenyl or naphthyl; or
M^{r+}/r,
M^{r+} is an r-valent metal cation,
n is 1, 2, 3, 4, 5 or 6, and
r is 1, 2, 3 or 4.

7. A process according to claim 5, which comprises using a compound of formula II, III, IV, V or VI 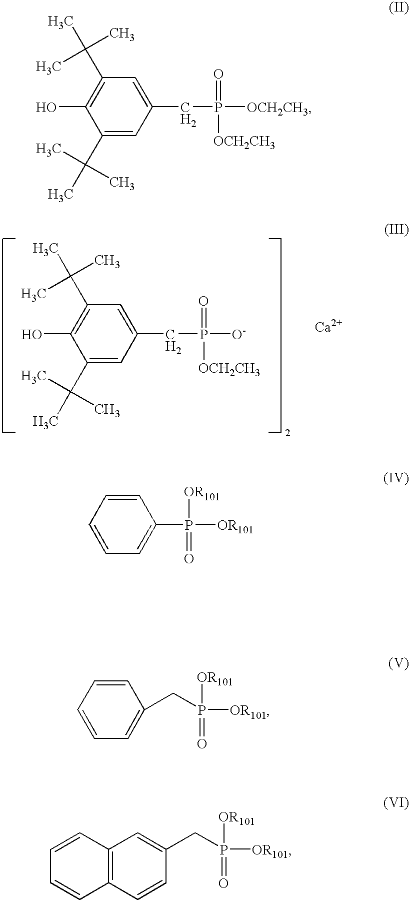
wherein the R₁₀₁ are each independently of one another hydrogen or M^{r+}/r.

8. A process according to claim 1 wherein 10 to 20 000 ppm of the phosphonate per monomer or monomers are used.

9. A process according to claim 1 wherein the polycondensation or polyaddition temperature is between 150° C. and 280° C.

10. A process according to claim 1 wherein the pressure during the polycondensation or polyaddition reaction is between 3 and 20 bar.

11. A process according to claim 1 wherein a subsequent solid state polycondensation is applied to the polyamide prepolymer.

12. A composition comprising
a) a diacid and a diamine monomer or a lactam monomer and
b) a phosphonate.

13. Use of a phosphonate for the preparation of a polyamide prepolymer comprising starting from a diacid and a diamine monomer or from a lactam monomer and carrying out a polycondensation or polyaddition reaction in the presence of the phosphonate.

14. A polyamide obtainable according to the process of claim 1.
